(19) United States
(12) Patent Application Publication
(10) Pub. No.: US 2026/0349932 A1
(43) Pub. Date: Nov. 5, 2026

(54) DISPLAY DEVICE AND TEST METHOD FOR PIXEL CIRCUIT THEREOF

(71) Applicant: NOVATEK Microelectronics Corp., Hsinchu (TW)

(72) Inventors: Chien-Ju Lai, Changhua County (TW); En Tsung, Taoyuan City (TW); Ya-Hsiang Tai, Miaoli County (TW); Hua-Wei Liu, New Taipei City (TW); Chih-Chang Lai, Taichung City (TW)

(73) Assignee: NOVATEK Microelectronics Corp., Hsinchu (TW)

(21) Appl. No.: 19/740,260

(22) Filed: Jul. 14, 2026

(30) Foreign Application Priority Data
Apr. 29, 2026 (TW) 115116801

(51) Int. Cl. G06F 12/1072

(52) U.S. Cl. CPC G06F 12/1072; G06F 2212/656

(57) ABSTRACT

A display device and a test method for pixel circuit thereof are provided. The display device includes a pixel circuit, a switch circuit and a voltage readout circuit. The pixel circuit includes a storage capacitor, a driving transistor, a first voltage write-in channel, a voltage readout channel and a light-emitting element. In a test mode, the first voltage write-in channel is used to write a test voltage to the storage capacitor, and the voltage readout channel is used to transmit a readout voltage through a data line. The voltage readout circuit, in the test mode, is coupled to a data line through the switch circuit to receive the readout voltage from the voltage readout channel.

### CROSS-REFERENCE TO RELATED APPLICATION

This application claims the priority benefit of Taiwan application serial no. 115116801, filed on Apr. 29, 2026. The entirety of the above-mentioned patent application is hereby incorporated by reference herein and made a part of this specification.

### BACKGROUND

### Technical Field

The disclosure relates to a display device and a test method for a pixel circuit thereof, and in particular relates to a display device and a test method for a pixel circuit thereof that enable low-cost, real-time testing.

### Description of Related Art

In the current technological field, methods for detecting pixel and panel defects in displays primarily include automated optical inspection (AOI), electrical testing, and manual visual inspection. The foregoing methods are, for the most part, conducted prior to product shipment, and determine whether defects are present by observing pixel luminance and/or overall image uniformity. Such inspection approaches present the following deficiencies: post-delivery defect detection relies on human visual inspection, which is of low accuracy and time-consuming; they fail to address potential anomalies arising after product installation, particularly with respect to high-value products (e.g., automotive displays); and inspection costs are high, requiring substantial equipment and labor, and they do not satisfy real-time monitoring requirements.

### SUMMARY

A display device and a test method for a pixel circuit thereof, which may perform real-time testing of the pixel circuit to meet safety requirements, are provided in the disclosure.

A display device of the disclosure includes a pixel circuit, a switch circuit, and a voltage readout circuit. The pixel circuit includes a storage capacitor, a driving transistor, a first voltage write-in channel, a voltage readout channel, and a light-emitting element. The voltage readout channel is coupled to a data line. In a test mode, the first voltage write-in channel is configured to write a test voltage to the storage capacitor, and the voltage readout channel transmits a readout voltage through the data line. The voltage readout circuit is coupled to the switch circuit. In the test mode, the voltage readout circuit is coupled to the data line through the switch circuit to receive the readout voltage transmitted by the voltage readout channel.

A display device of the disclosure includes multiple pixel circuits, multiple switch circuits, multiple voltage readout circuits, and multiple data processing circuits. Each of the pixel circuits includes a storage capacitor, a driving transistor, a first voltage write-in channel, a voltage readout channel, and a light-emitting element. The voltage readout channel is coupled to a data line. In a test mode, the first voltage write-in channel is configured to write a test voltage to the storage capacitor, and the voltage readout channel transmits a readout voltage through the data line. Each of the switch circuits is coupled to the corresponding data line. Each of the voltage readout circuits is coupled to the corresponding switch circuit. In the test mode, each of the voltage readout circuits is coupled to each of the data lines through each of the switch circuits to receive each of the readout voltages transmitted by each of the voltage readout channels. The data processing circuits are respectively coupled to the voltage readout circuits. In the test mode, whether an abnormality has occurred in each of the pixel circuits is determined according to each of the readout voltages.

A test method for a pixel circuit of the disclosure includes the following operation. A first voltage write-in channel and a voltage readout channel are set in the pixel circuit, in which the pixel circuit has a storage capacitor, a driving transistor, and a light-emitting element. In a test mode, the first voltage write-in channel is provided for writing a test voltage to the storage capacitor. A switch circuit is provided which, in the test mode, couples the voltage readout channel to a data line, and a readout voltage is transmitted through the data line. A voltage readout circuit is provided, which, in the test mode, is coupled to the data line through the switch circuit to receive the readout voltage transmitted by the voltage readout channel.

Based on the above, the display device of the disclosure performs test voltage writing and readout voltage reading operations on the storage capacitor in the pixel circuit in test mode through the voltage write-in channel and the voltage readout channel provided in the circuit architecture of the pixel circuit. Furthermore, the readout voltage is obtained from the data line through a voltage readout circuit, enabling the display device to determine in real time whether an abnormality has occurred in the pixel circuit according to the readout voltage, thereby satisfying safety requirements.

### BRIEF DESCRIPTION OF THE DRAWINGS

FIG. 1 is a schematic diagram of a display device of an embodiment of the disclosure.

FIGS. 2A - 2C are schematic diagrams of a display device of another embodiment of the disclosure and its circuit operation in a test mode.

FIG. 3 is a waveform of the output voltage of the display device during the test operation under normal conditions of the embodiment of FIG. 2A of the disclosure.

FIG. 4 is a schematic diagram of a display device of another embodiment of the disclosure.

FIGS. 5A - 5D respectively illustrate the waveforms of the output voltage of the display device under various abnormal states according to embodiments of the disclosure.

FIG. 6 is a flowchart of the test operation of a pixel circuit of an embodiment of the disclosure.

### DETAILED DESCRIPTION OF DISCLOSED EMBODIMENTS

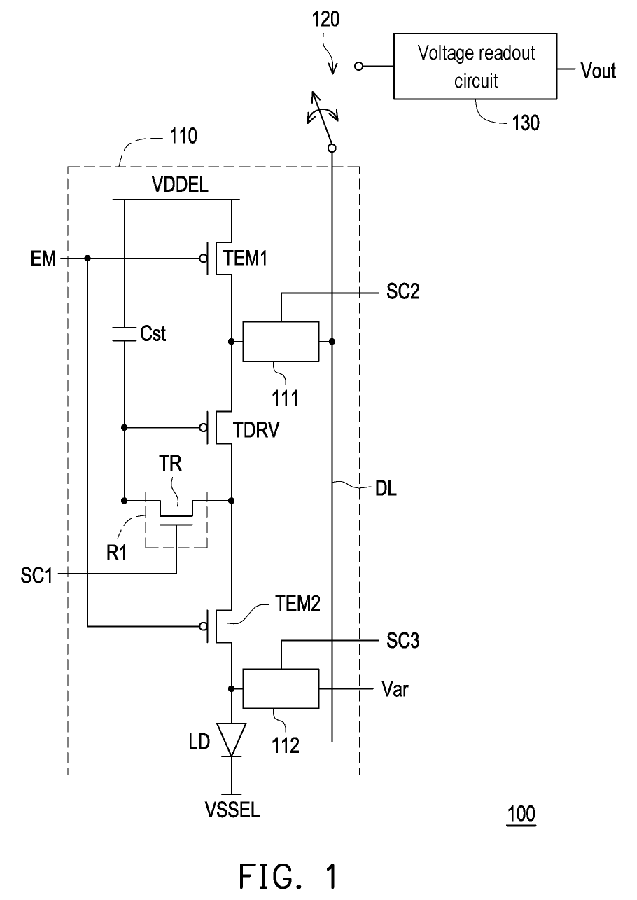

Referring to FIG. 1, FIG. 1 is a schematic diagram of a display device of an embodiment of the disclosure. A display device 100 includes a pixel circuit 110, a switch circuit 120, and a voltage readout circuit 130. The pixel circuit 110 includes a driving transistor TDRV, a storage capacitor Cst, a voltage write-in channel 112, a voltage readout channel 111, and a light-emitting element LD. A first terminal of the driving transistor TDRV receives a power supply voltage VDDEL through a transistor TEM1, and a second terminal of the driving transistor TDRV is coupled to the light-emitting element LD through a transistor TEM2. A first terminal of the storage capacitor Cst receives the power supply voltage VDDEL, and a second terminal of the storage capacitor Cst is coupled to a control terminal of the driving transistor TDRV. In this embodiment, the transistors TEM1 and TEM2 serve as switching elements and are controlled by a control signal EM. When the transistors TEM1 and TEM2 are rendered conductive according to the control signal EM, the driving transistor TDRV is connected in series with the light-emitting element LD between the power supply voltage VDDEL and a reference ground voltage VSSEL.

The transistor TR is coupled between the second terminal of the storage capacitor Cst and the second terminal of the driving transistor TDRV. The transistor TR may be controlled by a control signal SC1, and in a test mode, the transistor TR may operate in the linear region and is equivalent to a resistor R1.

The voltage write-in channel 112 is coupled to an anode of the light-emitting element LD and is controlled by a control signal SC3. In the test mode, a first terminal of the voltage write-in channel 112 receives a test voltage Var. The voltage write-in channel 112 is rendered conductive according to a control signal SC3, and the test voltage Var is written to the second terminal of the storage capacitor Cst through the conductive transistor TEM2 and the resistor R1.

The voltage readout channel 111 is coupled between the first terminal of the driving transistor TDRV and a data line DL. The voltage readout channel 111 is controlled by the control signal SC2 and is rendered conductive according to the control signal SC2 in test mode. Therefore, the voltage readout channel 111 may transmit the voltage on the second terminal of the storage capacitor Cst to the data line DL through the resistor R1 and the driving transistor TDRV to generate a readout voltage.

As may be seen from the above description, in the test mode, the display device 100 may write the test voltage Var into the storage capacitor Cst through the voltage write-in channel 112, and then transmit the readout voltage to the data line DL through the voltage readout channel 111 according to the voltage on the second terminal of the storage capacitor Cst.

Furthermore, in the test mode, the switch circuit 120 may couple the data line DL to the voltage readout circuit 130. In this way, the voltage readout circuit 130 may obtain the readout voltage transmitted by the voltage readout channel 111 from the data line DL through the switch circuit 120, and generate the output voltage Vout according to the obtained readout voltage.

In this way, the display device 100 may determine whether an abnormality has occurred in the pixel circuit 110 according to the waveform difference between the readout voltage and a preset ideal readout voltage.

In this embodiment, the voltage readout circuit 130 may be, for example, an analog front end (AFE) circuit. This AFE circuit may be constructed, for example, using a signal integrator.

It is further noted that, the switch circuit 120 may couple the data line DL to a source line of a source driver in a normal display mode of the display device 100. The switch circuit 120 may be set in a touch with display driver integration (TDDI) circuit. In the test mode, the TDDI circuit may select the pixel circuit for detection based on a clock signal and a scan signal.

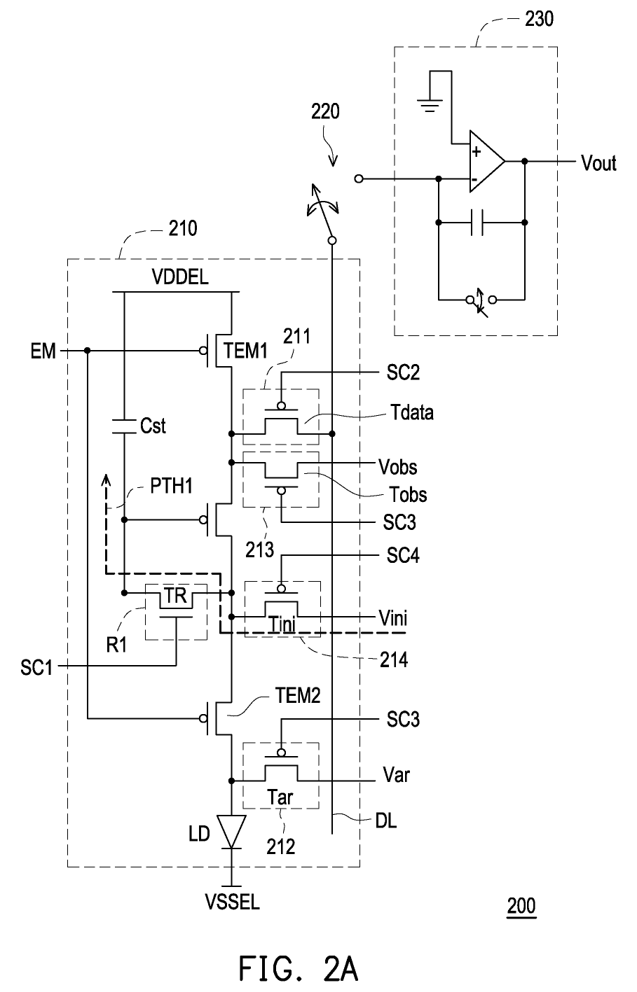

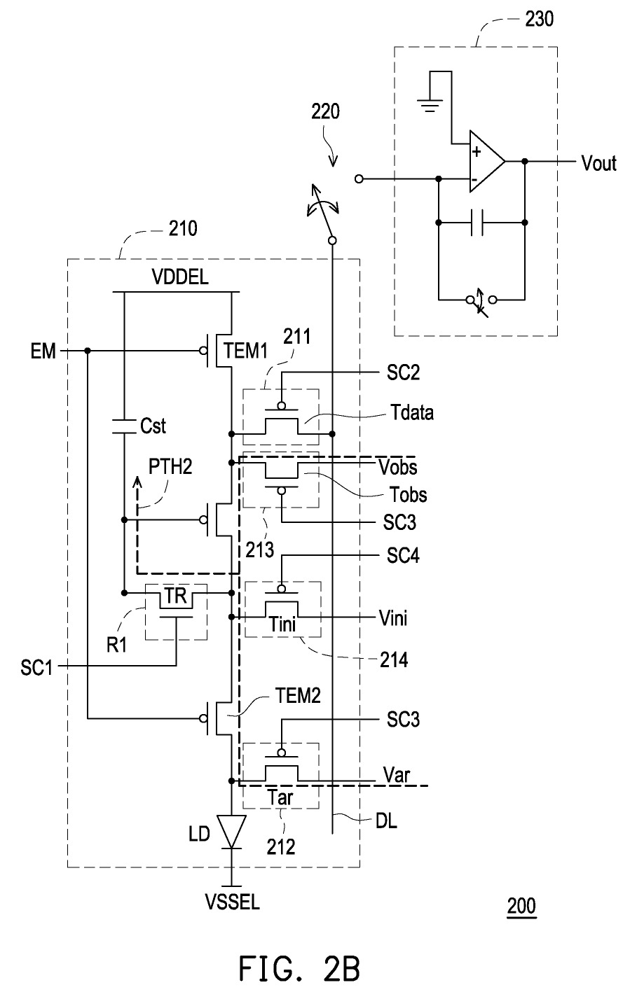

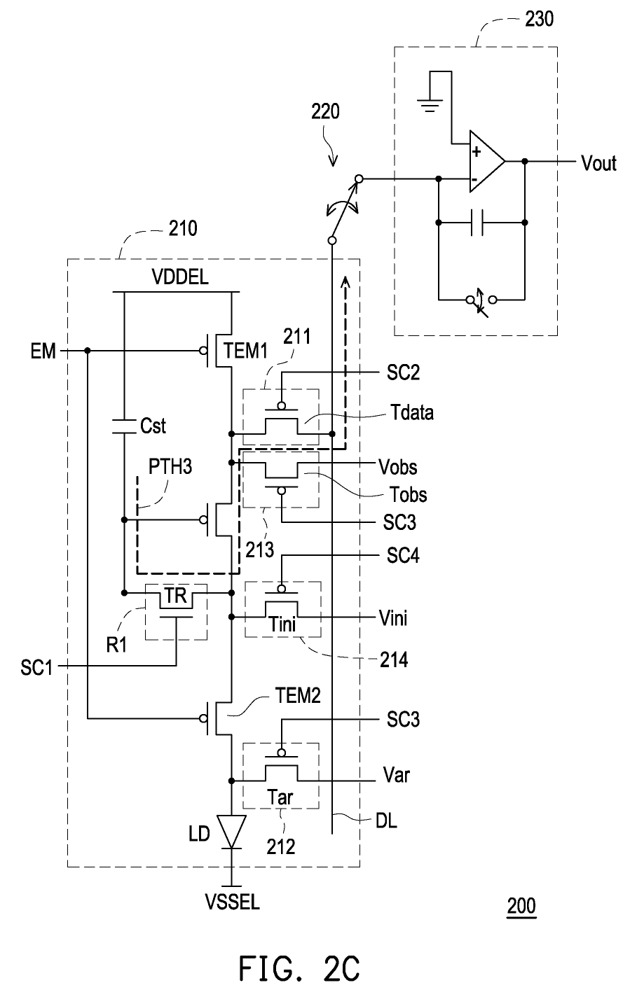

Hereinafter, reference is made to FIGS. 2A - 2C, FIGS. 2A - 2C. are schematic diagrams of a display device of another embodiment of the disclosure and its circuit operation in a test mode. In FIG. 2A, a display device 200 includes a pixel circuit 210, a switch circuit 220, and a voltage readout circuit 230. The pixel circuit 210 includes a driving transistor TDRV, a storage capacitor Cst, voltage write-in channels 212 and 213, a voltage readout channel 211, a voltage initialization channel 214, transistors TEM1 and TEM2, a resistor R1, and a light-emitting element LD. The voltage readout circuit 230 is a signal integrator configured to generate a readout voltage Vout.

In this embodiment, the coupling relationship between the driving transistor TDRV, the transistors TEM1 and TEM2, a transistor TR constituting the resistor R1, and the storage capacitor Cst is the same as that of the pixel circuit 110 in the embodiment of FIG. 1, and is not repeated herein.

Different from the embodiment of FIG. 1, in this embodiment, the voltage readout channel 211 is constructed by a transistor Tdata. The transistor Tdata is coupled between a first terminal of the driving transistor TDRV and a data line DL. A control terminal of the transistor Tdata receives a control signal SC2 and is rendered conductive or cut off according to the control signal SC2. The voltage write-in channel 212 is constructed by a transistor Tar. In a test mode, a first terminal of the transistor Tar receives a test voltage Var. A second terminal of transistor Tar is coupled between coupling terminals of the light-emitting element LD and the driving transistor TDRV (through the transistor TEM2), and a control terminal of the transistor Tar receives a control signal SC3 and is rendered conductive or cut off according to the control signal SC3.

In addition, the pixel circuit 210 has another voltage write-in channel 213. The voltage write-in channel 213 is constructed by a transistor Tobs. In the test mode, a first terminal of the transistor Tobs receives a test voltage Vobs. A second terminal of the transistor Tobs is coupled to the first terminal of the driving transistor TDRV, and a control terminal of the transistor Tobs receives the control signal SC3 and is rendered conductive or non-conductive according to the control signal SC3.

The pixel circuit 210 further has the voltage initialization channel 214. The voltage initialization channel 214 is constructed by a transistor Tini. A first terminal of the transistor Tini receives an initialization voltage Vini. A second terminal of the transistor Tini is coupled to a second terminal of the storage capacitor Cst, and a control terminal of the transistor Tini receives a control signal SC4 and is rendered conductive or cut off according to the control signal SC4.

In terms of operation, the display device 200 of this embodiment, in the test mode, may be divided into an initialization period, a test voltage writing period, and a readout voltage reading period. In FIG. 2A, the display device 200 is in the initialization period; in FIG. 2B, the display device 200 is in the test voltage writing period; and in FIG. 2C, the display device 200 is in the readout voltage reading period.

In FIG. 2A, the transistor TR operates in the linear region according to a control signal SC1 and is equivalent to the resistor R1. The transistor Tini in the voltage initialization channel 214 is rendered conductive according to the control signal SC4 and transmits the received initialization voltage Vini, via a path PTH1 and through the resistor R1, to the second terminal of the storage capacitor Cst. Accordingly, the initialization voltage Vini is written to the storage capacitor Cst. At the same time, the transistors Tar and Tobs in the voltage write-in channels 212 and 213 are rendered non-conductive according to the same control signal SC3. In this embodiment, the initialization voltage Vini may be, for example, -2 volts. By writing the initialization voltage Vini to the second terminal of the storage capacitor Cst (which is coupled to the control terminal of the driving transistor TDRV), it may be ensured that the driving transistor TDRV remains in an "on state" during subsequent operations of the test mode.

In FIG. 2B, the transistor TR operates in the linear region according to the control signal SC1 and is equivalent to the resistor R1. The transistor Tini is rendered non-conductive according to the control signal SC4, the voltage initialization channel 214 is cut off and the transmission of the initialization voltage Vini to the storage capacitor Cst is discontinued. The transistors Tar and Tobs are synchronously rendered conductive according to the control signal SC3, thereby rendering the voltage write-in channels 212 and 213 conductive. In this way, the test voltage Var may be written to the second terminal of the storage capacitor Cst via a path PTH2 through the resistor R1. The test voltage Vobs may be written to the second terminal of the storage capacitor Cst via the path PTH2 through the driving transistor TDRV and the resistor R1. The test voltages Var and Vobs may have the same voltage value, for example, -2 volts.

It is worth noting that during the test voltage writing period, the transistor Tdata is rendered non-conductive according to the control signal SC2, thereby cutting off the voltage readout channel 211.

After a preset time has elapsed following completion of writing the test voltages Var and Vobs to the second terminal of the storage capacitor Cst, the readout voltage reading period may be entered. In FIG. 2C, the transistor Tini is rendered non-conductive according to the control signal SC4, and the transistors Tar and Tobs are rendered non-conductive according to the control signal SC3. The voltage initialization channel 214 and the voltage write-in channels 211 and 212 are each cut off. The transistor Tdata is rendered conductive according to the control signal SC2, thereby rendering the voltage readout channel 211 conductive. The transistor TR is maintained as an equivalent resistor R1.

In this way, the voltage on the second terminal of the storage capacitor Cst may be transmitted to the data line DL via a transmission path PTH3 through the resistor R1, the driving transistor TDRV and the voltage readout channel 211, thereby generating a readout voltage. Correspondingly, during the readout voltage reading period, the switch circuit 220 may couple the data line DL to the voltage readout circuit 230. The voltage readout circuit 230 may integrate the readout voltage on the data line DL and thereby generate an output voltage Vout.

It is worth noting that the test mode of this embodiment of the disclosure may be performed at any time when the display device 200 is in an idle state. Accordingly, real-time monitoring of the pixel circuit 210 is achieved, thereby enhancing the operational safety of the display device 200.

In this embodiment of the disclosure, the initialization voltage Vini and the test voltages Var and Vobs may all be pulse wave voltages. The initialization voltage Vini and the test voltages Var and Vobs may be provided by the gate on array (GOA) in the display device 200. In a normal display mode (non-test mode), the test voltages Var and Vobs may be the reset voltage and bias voltage, respectively.

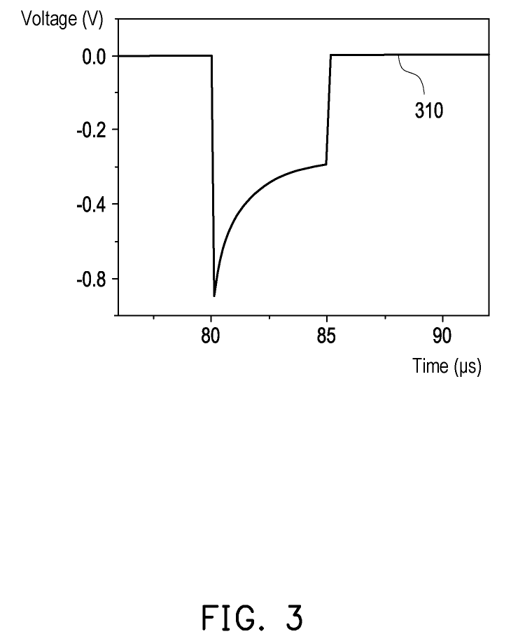

Referring to FIG. 3, FIG. 3 is a waveform of the output voltage of the display device during the test operation under normal conditions of the embodiment of FIG. 2A of the disclosure. When no abnormal open circuit or short circuit occurs at any contact in the pixel circuit 210 of the display device 200, the waveform of the output voltage Vout generated by the voltage readout circuit 230 in the test mode may be shown as waveform 310 in FIG. 3. Specifically, at the instant (time point t1) when the switch circuit 220 couples the data line DL to the voltage readout circuit 230, the output voltage Vout may drop rapidly. Next, as the voltage readout circuit 230 integrates the readout voltage on the data line DL, the output voltage Vout may rise slowly. The voltage across the storage capacitor Cst may exhibit an exponential decay phenomenon.

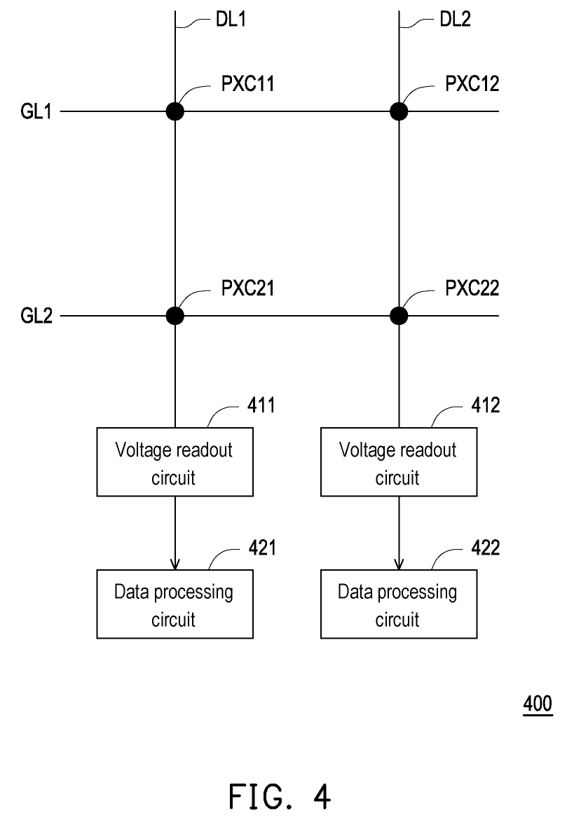

Referring to FIG. 4, FIG. 4 is a schematic diagram of a display device of another embodiment of the disclosure. A display device 400 includes multiple pixel circuits PXC11 to PXC22, multiple voltage readout circuits 411 and 412, and multiple data processing circuits 421 and 422. The pixel circuits PXC11 to PXC22 are arranged in an array, in which the pixel circuits PXC11 and PXC12 are coupled to the same scan line GL1; the pixel circuits PXC21 and PXC22 are coupled to the same scan line GL2; the pixel circuits PXC11 and PXC21 are coupled to the same data line DL1; the pixel circuits PXC12 and PXC22 are coupled to the same data line DL2.

The voltage readout circuit 411 may be coupled to the data line DL1 through a switch circuit (as shown in the switch circuit 120 in FIG. 2), and the voltage readout circuit 412 may be coupled to the data line DL2 through a switch circuit (as shown in the switch circuit 120 in FIG. 2). The data processing circuits 421 and 422 are respectively coupled to the voltage readout circuits 411 and 412, and respectively process the output voltage generated by the voltage readout circuits 411 and 412 to determine whether an abnormality has occurred in any one of the pixel circuits PXC11 to PXC22.

In this embodiment, the data processing circuits 421 and 422 may be analog-to-digital converter circuits to convert the analog output voltages generated by voltage readout circuits 411 and 412 into digital codes. Through computation of the digital codes, it may be determined whether an abnormality has occurred in any one of the pixel circuits PXC11 to PXC22. For details on determining whether an abnormality has occurred in the pixel circuits PXC11 to PXC2, please refer to the following description.

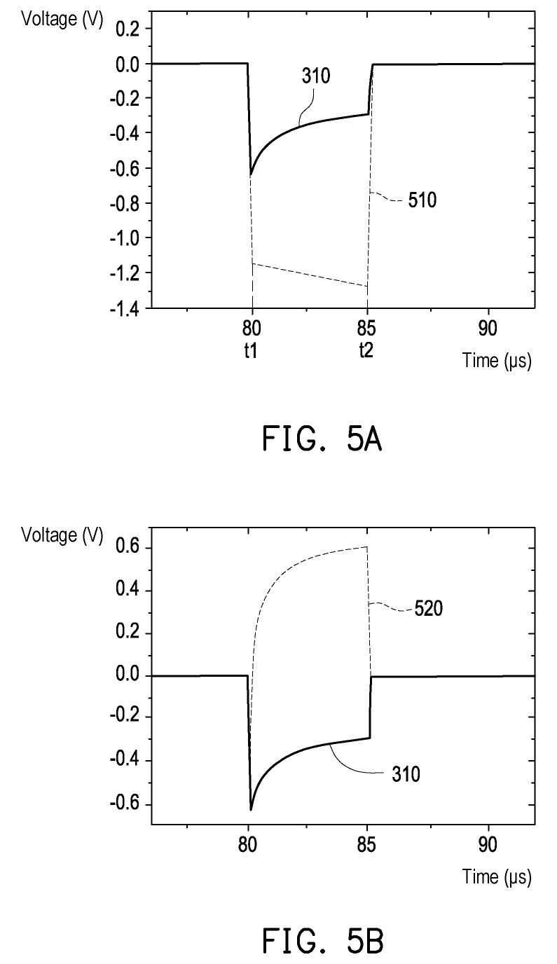

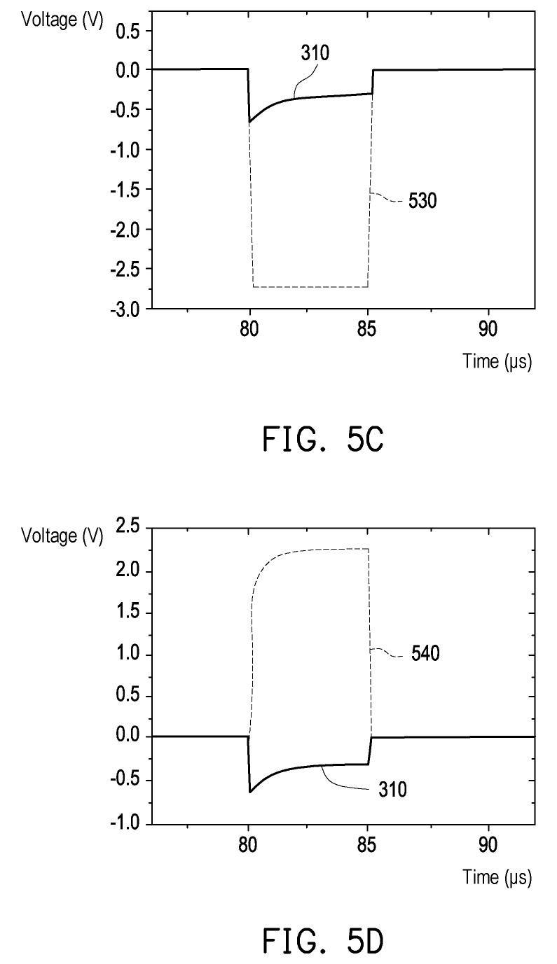

Hereinafter, reference is made to FIGS. 5A - 5D, FIGS. 5A - 5D. respectively illustrate the waveforms of the output voltage of the display device under various abnormal states according to embodiments of the disclosure. FIG. 5A exemplifies an abnormal state where the first terminal of the storage capacitor Cst in the embodiment of FIG. 2 is open-circuited with the power supply voltage VDDEL. The storage capacitor Cst loses its charging and discharging capability and becomes a floating node. This causes the voltage at the second terminal of the storage capacitor Cst to be mainly affected by the parasitic coupling caused by the switching of the data line DL and the driving transistor TDRV, which in turn causes abnormal fluctuations in the output voltage Vout during the readout voltage reading period in the test mode. The waveform 510 of the abnormal output voltage Vout and the waveform 310 of the normal output voltage Vout have a certain degree of voltage difference between time points t1 and t2.

In this embodiment, the data processing circuit may convert the waveform 510 of the abnormal output voltage Vout into multiple readout digital codes at multiple time sampling points between time points t1 and t2 according to the set resolution. The data processing circuit may also pre-store multiple ideal digital codes corresponding to the waveform 310 of the normal output voltage Vout at the above-mentioned sampling time points. By comparing each readout digital code with the corresponding ideal digital code data, the processing circuit may determine whether the pixel circuit under test is in an abnormal state according to the difference between each readout digital code and the corresponding ideal digital code data.

The data processing circuit may set a threshold value, and when the maximum value among the differences between each readout digital code and the corresponding ideal digital code data is greater than this threshold value, the data processing circuit determines that the corresponding pixel circuit is abnormal.

In this embodiment, the maximum voltage difference between waveforms 310 and 510 is as high as 991 millivolts. In a 12-bit analog-to-digital conversion operation, this voltage difference may reach 1357 least significant bits, which is about 1/4 of the full-scale range of 12-bit data, thereby providing a fairly reliable degree of identification.

The above-mentioned anomalies may be determined according to an average value of the differences between the ideal digital codes and the readout digital codes. When the average value of the differences between the ideal digital codes and the readout digital codes is greater than a preset threshold value, it may be determined that the corresponding pixel circuit is abnormal.

FIG. 5B exemplifies an open circuit at the connection between the first terminal of the driving transistor TDRV and the transistor TEM1 in the embodiment of FIG. 2. The first terminal of the driving transistor TDRV is not driven by the power supply voltage VDDEL, but when the test voltage Vobs is written, the first terminal of the driving transistor TDRV is affected by the test voltage Vobs and pulled back to -2 volts. When the test voltage Vobs (=−2 V) is written to the storage capacitor Cst, the waveform 520 of the output voltage Vout still shows the characteristics of capacitor charging and discharging, but its polarity is reversed compared to the normal waveform 310, indicating abnormal output behavior caused by incorrect storage voltage.

In this embodiment, the maximum voltage difference between waveforms 310 and 520 is as high as 896 millivolts. In a 12-bit analog-to-digital conversion operation, this voltage difference may reach 1227 least significant bits, which is up to 1/4 of the full-scale range of 12-bit data, thereby providing a fairly reliable degree of identification.

FIG. 5C exemplifies a short circuit between the first terminal and the second terminal of the driving transistor TDRV in the embodiment of FIG. 2. The driving transistor TDRV will remain in the "on state". In this way, during the readout voltage reading period, the charge stored in the storage capacitor Cst continues to be transmitted to the voltage readout circuit 230 through the short-circuit path between the first terminal and the second terminal of the driving transistor TDRV. Even if the voltage at the control terminal of the driving transistor TDRV drops below its threshold voltage, causing the driving transistor TDRV to be rendered non-conductive, the charge stored in the storage capacitor Cst will continue to be read out by the voltage readout circuit 230 because the short circuit between the first terminal and the second terminal of the driving transistor TDRV still exists, until the transistor Tdata is turned off. Therefore, the output voltage Vout of the voltage readout circuit 230 is significantly higher (e.g., waveform 520) than normal, forming a clearly identifiable short-circuit defect characteristic.

In this embodiment, the maximum voltage difference between waveforms 310 and 530 is as high as 2.44 volts. In a 12-bit analog-to-digital conversion operation, this voltage difference may reach 3342 least significant bits, which is up to 3/4 of the full-scale range of 12-bit data, thereby providing a fairly reliable degree of identification.

FIG. 5D exemplifies a short circuit between an anode terminal of the light-emitting element LD and the control terminal of the transistor Tobs in the embodiment of FIG. 2. During the test voltage writing period, the anode terminal of the light-emitting element LD is pulled to -9 volts corresponding to the control signal SC3. In this way, an unexpected voltage is stored in the storage capacitor Cst. This causes the output voltage Vout generated by the voltage readout circuit 230 to exhibit a significantly different voltage amplitude and polarity (e.g., waveform 540) compared to normal, forming a highly identifiable short-circuit defect characteristic.

In this embodiment, the maximum voltage difference between waveforms 310 and 540 is as high as 2.57 volts. In a 12-bit analog-to-digital conversion operation, this voltage difference may reach 3520 least significant bits, which is up to 3/4 of the full-scale range of 12-bit data, thereby providing a fairly reliable degree of identification.

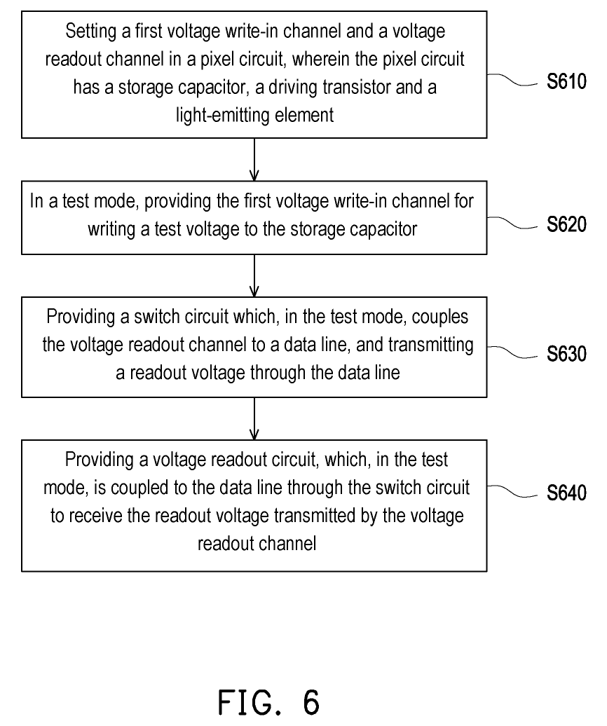

Referring to FIG. 6, FIG. 6 is a flowchart of the test operation of a pixel circuit of an embodiment of the disclosure. In step S610, a first voltage write-in channel and a voltage readout channel are set in a pixel circuit, in which the pixel circuit has a storage capacitor, a driving transistor and a light-emitting element. In step S620, in a test mode, the first voltage write-in channel is provided for writing a test voltage to the storage capacitor. In step S630, a switch circuit is provided which, in the test mode, couples the voltage readout channel to a data line, and a readout voltage is transmitted through the data line. Furthermore, in step S640, a voltage readout circuit is provided which, in the test mode, is coupled to the data line through the switch circuit to receive the readout voltage transmitted by the voltage readout channel.

The implementation details of the above steps have been described in detail in the foregoing embodiment, and are not repeated herein.

In summary, the disclosure forms, through circuit elements in a pixel circuit, a voltage write-in channel and a voltage readout channel. In a test mode, during a test voltage writing period under a test mode, a test voltage is written to a storage capacitor through the voltage write-in channel, and during a subsequent readout voltage reading period, a readout voltage on the storage capacitor is read through the voltage readout channel. Based on the voltage state of the readout voltage, the display device may determine whether an abnormality has occurred the pixel circuit, thereby maintaining the operational safety of the display device.

What is claimed is:

1. A display device, comprising:
a pixel circuit, comprising a storage capacitor, a driving transistor, a first voltage write-in channel, a voltage readout channel, and a light-emitting element, wherein the voltage readout channel is coupled to a data line, in a test mode, the first voltage write-in channel is configured to write a test voltage to the storage capacitor, and the voltage readout channel transmits a readout voltage through the data line;
a switch circuit, coupled to the data line; and
a voltage readout circuit, coupled to the switch circuit, wherein in the test mode, the voltage readout circuit is coupled to the data line through the switch circuit to receive the readout voltage transmitted by the voltage readout channel.

2. The display device according to claim 1, wherein a first terminal of the storage capacitor receives a power supply voltage, and a second terminal of the storage capacitor is coupled to a control terminal of the driving transistor.

3. The display device according to claim 2, wherein a first terminal of the first voltage write-in channel receives the test voltage, and a second terminal of the first voltage write-in channel is coupled between mutual coupling terminals of the driving transistor and the light-emitting element and is coupled to the second terminal of the storage capacitor through a resistor.

4. The display device according to claim 2, wherein a first terminal of the voltage readout channel is coupled to the data line, and a second terminal of the voltage readout channel is coupled to a first terminal of the driving transistor and is coupled to the second terminal of the storage capacitor through the driving transistor and a resistor.

5. The display device according to claim 2, wherein the pixel circuit further comprises:
a voltage initialization channel, having a first terminal for receiving an initialization voltage, wherein a second terminal of the voltage initialization channel is coupled to the second terminal of the storage capacitor.

6. The display device according to claim 5, wherein during an initialization period in the test mode, the voltage initialization channel writes the initialization voltage to the second terminal of the storage capacitor.

7. The display device according to claim 2, wherein the pixel circuit further comprises:
a second voltage write-in channel, wherein in the test mode, a first terminal of the second voltage write-in channel receives the test voltage, and a second terminal of the second voltage write-in channel is coupled to a first terminal of the driving transistor and coupled to the second terminal of the storage capacitor through the driving transistor and a resistor.

8. The display device according to claim 2, wherein the pixel circuit further comprises:
a resistor, coupled between mutual coupling terminals of the driving transistor and the light-emitting element and the second terminal of the storage capacitor,
wherein the resistor is a transistor resistor and is controlled by a control signal.

9. The display device according to claim 8, wherein in the test mode, after the first voltage writing channel completes writing of the test voltage, the control signal renders the transistor resistor non-conductive, after a preset time has elapsed following the transistor resistor being rendered non-conductive, a readout voltage reading period of the test mode is entered so that the voltage readout channel transmits the readout voltage to the voltage readout circuit.

10. A display device, comprising:
a plurality of pixel circuits, each of the pixel circuits comprising a storage capacitor, a driving transistor, a first voltage write-in channel, a voltage readout channel, and a light-emitting element, wherein the voltage readout channel is coupled to a data line, in a test mode, the first voltage write-in channel is configured to write a test voltage to the storage capacitor, and the voltage readout channel transmits a readout voltage through the data line;
a plurality of switch circuits, wherein each of the switch circuits is coupled to the corresponding data line;
a plurality of voltage readout circuits, wherein each of the voltage readout circuits is coupled to the corresponding switch circuit, in the test mode, each of the voltage readout circuits is coupled to each of the data lines through each of the switch circuits to receive each of the readout voltages transmitted by each of the voltage readout channels to generate an output voltage; and
a plurality of data processing circuits, respectively coupled to the voltage readout circuits, determining, in the test mode, whether an abnormality has occurred in each of the pixel circuits according to each of the output voltages.

11. The display device according to claim 10, wherein each of the data processing circuits converts the output voltage into a plurality of readout digital codes at a plurality of time sampling points according to a set resolution, and determines whether the abnormality has occurred in each of the pixel circuits according to the readout digital codes and a plurality of ideal digital codes.

12. The display device according to claim 11, wherein each of the data processing circuits determines whether the abnormality has occurred in each of the pixel circuits according to a maximum value among differences between each of the readout digital codes and each of the corresponding ideal digital codes.

13. The display device according to claim 11, wherein each of the data processing circuits determines whether the abnormality has occurred in each of the pixel circuits according to an average value among differences between each of the readout digital codes and each of the corresponding ideal digital codes.

14. The display device according to claim 10, wherein a first terminal of the storage capacitor receives a power supply voltage, and a second terminal of the storage capacitor is coupled to a control terminal of the driving transistor, a first terminal of the first voltage write-in channel receives the test voltage, and a second terminal of the first voltage write-in channel is coupled between mutual coupling terminals of the driving transistor and the light-emitting element and is coupled to the second terminal of the storage capacitor through a resistor, a first terminal of the voltage readout channel is coupled to the data line, and a second terminal of the voltage readout channel is coupled to a first terminal of the driving transistor and is coupled to the second terminal of the storage capacitor through the driving transistor and the resistor.

15. The display device according to claim 14, wherein the pixel circuit further comprises a voltage initialization channel, the voltage initialization channel has a first terminal for receiving an initialization voltage, and a second terminal of the voltage initialization channel is coupled to the second terminal of the storage capacitor, wherein during an initialization period in the test mode, the voltage initialization channel writes the initialization voltage to the second terminal of the storage capacitor.

16. The display device according to claim 14, wherein the pixel circuit further comprises a second voltage write-in channel, wherein in the test mode, a first terminal of the second voltage write-in channel receives the test voltage, and a second terminal of the second voltage write-in channel is coupled to a first terminal of the driving transistor and coupled to the second terminal of the storage capacitor through the driving transistor and a resistor.

17. The display device according to claim 14, wherein the resistor is a transistor resistor and is controlled by a control signal.

18. The display device according to claim 17, wherein in the test mode, after the first voltage writing channel completes writing of the test voltage, the control signal renders the transistor resistor non-conductive, after a preset time has elapsed following the transistor resistor being rendered non-conductive, a readout voltage reading period of the test mode is entered so that the voltage readout channel transmits the readout voltage to the voltage readout circuit.

19. A test method for a pixel circuit, comprising:
setting a first voltage write-in channel and a voltage readout channel in the pixel circuit, wherein the pixel circuit has a storage capacitor, a driving transistor, and a light-emitting element;
in a test mode, providing the first voltage write-in channel for writing a test voltage to the storage capacitor;
providing a switch circuit which, in the test mode, couples the voltage readout channel to a data line, thereby transmitting a readout voltage through the data line; and
providing a voltage readout circuit which, in the test mode, is coupled to the data line through the switch circuit to receive the readout voltage transmitted by the voltage readout channel.

20. The test method for the pixel circuit according to claim 19, further comprising:
providing a second voltage write-in channel to receive the test voltage and write the test voltage to the storage capacitor.
